(19) United States
(12) Patent Application Publication
(10) Pub. No.: US 2013/0135295 A1
(43) Pub. Date: May 30, 2013

(54) METHOD AND SYSTEM FOR A AUGMENTED REALITY

(71) Applicants: Ke-Chun LI, New Taipei City (TW); Yeh-Kuang WU, New Taipei City (TW); Chien-Chung CHIU, Luodong Township (TW); Jing-Ming CHIU, Taipei City (TW)

(72) Inventors: Ke-Chun LI, New Taipei City (TW); Yeh-Kuang WU, New Taipei City (TW); Chien-Chung CHIU, Luodong Township (TW); Jing-Ming CHIU, Taipei City (TW)

(73) Assignee: INSTITUTE FOR INFORMATION INDUSTRY, Taipei (TW)

(21) Appl. No.: 13/538,786

(22) Filed: Jun. 29, 2012

(30) Foreign Application Priority Data
Nov. 29, 2011 (TW) 100143659

(51) Int. Cl. G06T 15/00

(52) U.S. Cl. 345/419

(57) ABSTRACT

A method for generating an augmented reality is provided. The method comprises: capturing a 3D target image and a 3D environment image from a target and an environment respectively, wherein the 3D target image and the 3D environment image are the 3D images with the depth values; capturing a foreground image from the 3D target image; estimating a display scale of the foreground image in a 3D environment image corresponding to a specified depth value according to the specified depth value in the 3D environment image; and augmenting the foreground image in the 3D environment image according to the display scale and generating an augmented reality image.

### CROSS REFERENCE TO RELATED APPLICATIONS

This Application claims priority of Taiwan Patent Application No. 100143659, filed on Nov. 29, 2011, the entirety of which is incorporated by reference herein.

### BACKGROUND OF THE INVENTION

1. Field of the Invention

The present invention relates to a system and method for augmented reality, and in particular relates to a system and method that may support stereo vision for augmented reality.

2. Description of the Related Art

Augmented Reality (commonly shortened to “AR”) often describes the view or image of a real-world environment that has been augmented with computer-generated content. Combining an image of the real-world environment with an image of computer-generated content has proven useful for many different applications. Augmented reality can be used in advertising, navigation, military, tourism, education, sports, and entertainment.

For many augmented reality applications, more than 2 images (two-dimensional images or three-dimensional images) are usually merged. For example, a virtual image established in advance or a specific object image extracted from an image is integrated into another environment image, and then the augmented reality image is presented. However, if a user wants to integrate the established image or the specific object image into another environment image, the relative position and scale between the two images must be calculated and then the image of the augmented reality can be displayed correctly and appropriately.

A specific pattern is usually used in the prior art for generating an augmented reality. The prior art method needs to establish a two-dimensional image/three-dimensional image corresponding to the specific pattern in advance, and estimate the relative position and scale between the two-dimensional image/three-dimensional image and the environment image based on the specific pattern. For example, FIG. 1 is a screenshot illustrating an augmented reality image. As illustrated, a user who holds such the specific pattern recognition 100 in front of a webcam will see a three-dimensional avatar 102 of the player on the computer screen. The three-dimensional image is shown after the three-dimensional image corresponding to the specific pattern and the environment image are integrated together according the position of the specific pattern and the three-dimensional image established corresponding to the specific pattern in advance. However, it is not convenient for using in the above method.

In addition, a reference object is used to estimate a scale of a target object in the prior art for generating an augmented reality. For example, an object with a specific scale (e.g. a 10 cm×10 cm×10 cm cube) or a standard scale has to be photographed when the environment is photographed. The scale of the environment image may be estimated according to the specific scale of the object or the standard scale, and then a three dimensional image may be integrated into the environment image appropriately according the scale of the environment and the scale of the three dimensional image established in advance. However, one drawback to this method is that the user has to carry an object with the specific scale or the standard scale, and put it in the environment when photographing. Furthermore, it is not convenient for the user to carry the object with the specific scale or the standard scale if the object is large. Also, if the specific scale of the object is small and the difference between the specific scale and the standard scale is large, the error between the estimated specific scale and the actual specific scale is large too. If the specific scale of the object is too large, it is difficult for the user to carry the object with him/her. Meanwhile, the object with a specific scale or the standard scale may occupy a large region in the environment image and may impair the sight of the environment.

Therefore, there is a need for a method and a system for augmented reality that can estimate the relative scale and position between the target object and the environment image and achieve the effect of augmented reality.

### BRIEF SUMMARY OF THE INVENTION

A detailed description is given in the following embodiments with reference to the accompanying drawings.

Methods and systems for generating an augmented reality are provided.

In one exemplary embodiment, the disclosure is directed to a method for generating an augmented reality, comprising: capturing a 3D target image and a 3D environment image from a target and an environment respectively, wherein the 3D target image and the 3D environment image are the 3D images with the depth values; capturing a foreground image from the 3D target image; estimating a display scale of the foreground image in a 3D environment image corresponding to a specified depth value according to the specified depth value in the 3D environment image; and augmenting the foreground image in the 3D environment image according to the display scale and generating an augmented reality image.

In one exemplary embodiment, the disclosure is directed to a system for generating an augmented reality, comprising: an image capturing unit, configured to capture a 3D target image and a 3D environment image from a target and an environment respectively, wherein the 3D target image and the 3D environment image are the 3D images with the depth values; a storage unit, coupled to the image capturing unit and is configured to store the 3D target image and the 3D environment image; a processing unit, coupled to the storage unit, comprising: a foreground capturing unit, configured to capture a foreground image from the 3D target image; a calculating unit, configured to estimate a display scale of the foreground image in a 3D environment image corresponding to a specified depth value according to the specified depth value in the 3D environment image; and an augmented reality unit, configured to augment the foreground image in the 3D environment image according to the display scale and generate an augmented reality image.

In one exemplary embodiment, the disclosure is directed to a mobile device for augmented reality, comprising an image capturing unit, configured to capture a 3D target image and a 3D environment image from a target and an environment respectively, wherein the 3D target image and the 3D environment image are the 3D images with the depth values; a storage unit, coupled to the image capturing unit and configured to store the 3D target image and the 3D environment image; a processing unit, coupled to the storage unit, comprising: a foreground capturing unit, configured to capture a foreground image from the 3D target image; a calculating unit, configured to estimate a display scale of the foreground image in a 3D environment image corresponding to a specified depth value according to the specified depth value in the 3D environment image; and an augmented reality unit, configured to augment the foreground image in the 3D environment image according to the display scale and generate an augmented reality image; and a display unit, coupled to the processing unit and is configured to display the augmented reality image.

### BRIEF DESCRIPTION OF THE DRAWINGS

The present invention can be more fully understood by reading the subsequent detailed description and examples with references made to the accompanying drawings, wherein:

FIG. 1 is a screenshot illustrating an augmented reality image of prior art;

FIG. 2A is a block diagram of a system used for generating an augmented reality according to a first embodiment of the present invention;

FIG. 2B is a block diagram of a system used for generating an augmented reality according to a second embodiment of the present invention;

FIG. 3A is a flow diagram illustrating the augmented reality method used in the augmented reality system according to the first embodiment of the present invention;

FIG. 3B is a flow diagram illustrating the augmented reality method used in the augmented reality system according to the second embodiment of the present invention;

FIG. 4A is a schematic view illustrating the capturing of a 3D target image by an image capturing unit;

FIG. 4B is a schematic view illustrating the capturing of a 3D environment image by an image capturing unit;

FIG. 4C is a schematic view illustrating the capturing of a foreground image by an image capturing unit;

FIG. 4D is a schematic view illustrating the height and the width of the foreground image;

FIGS. 5A-5B are schematic views illustrating the operation interface according to an embodiment of the present invention;

FIGS. 6A-6B are schematic views illustrating the operation interface according to an embodiment of the present invention;

FIGS. 6C-6D are schematic views illustrating the sequence of the depth value of the operation interface according to an embodiment of the present invention;

FIGS. 7A-7B are schematic views illustrating the operation interface according to an embodiment of the present invention;

FIGS. 8A-8B are schematic views illustrating the operation interface according to an embodiment of the present invention; and

FIGS. 9A-9B are schematic views illustrating the operation interface according to an embodiment of the present invention.

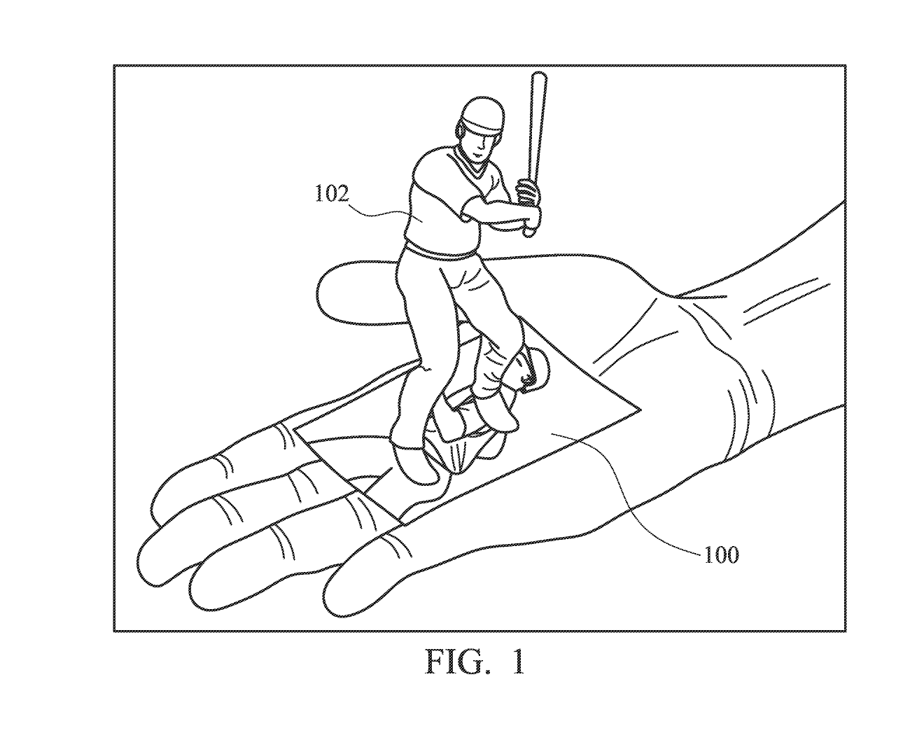

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

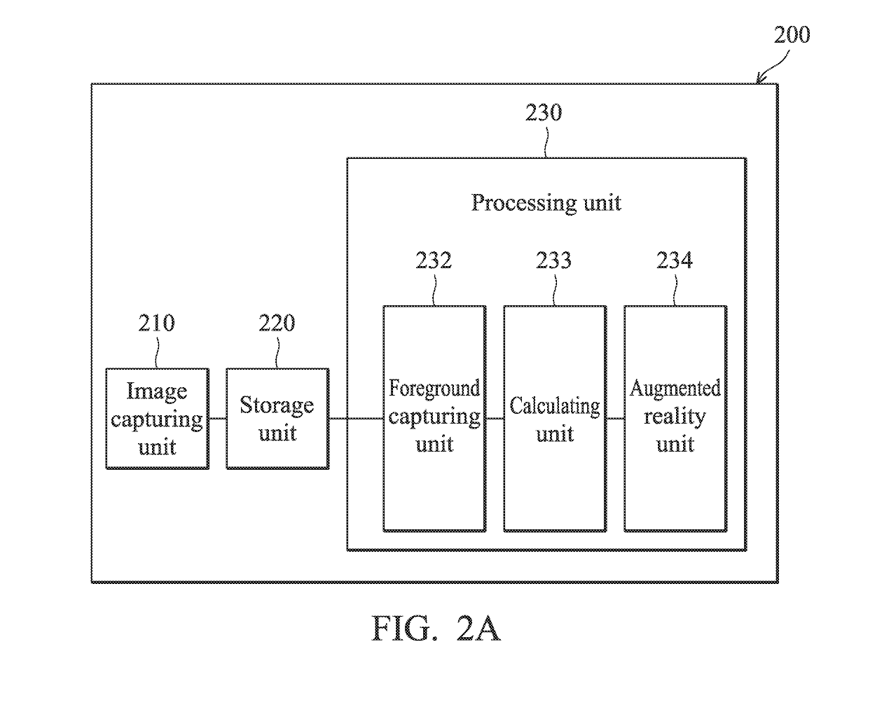

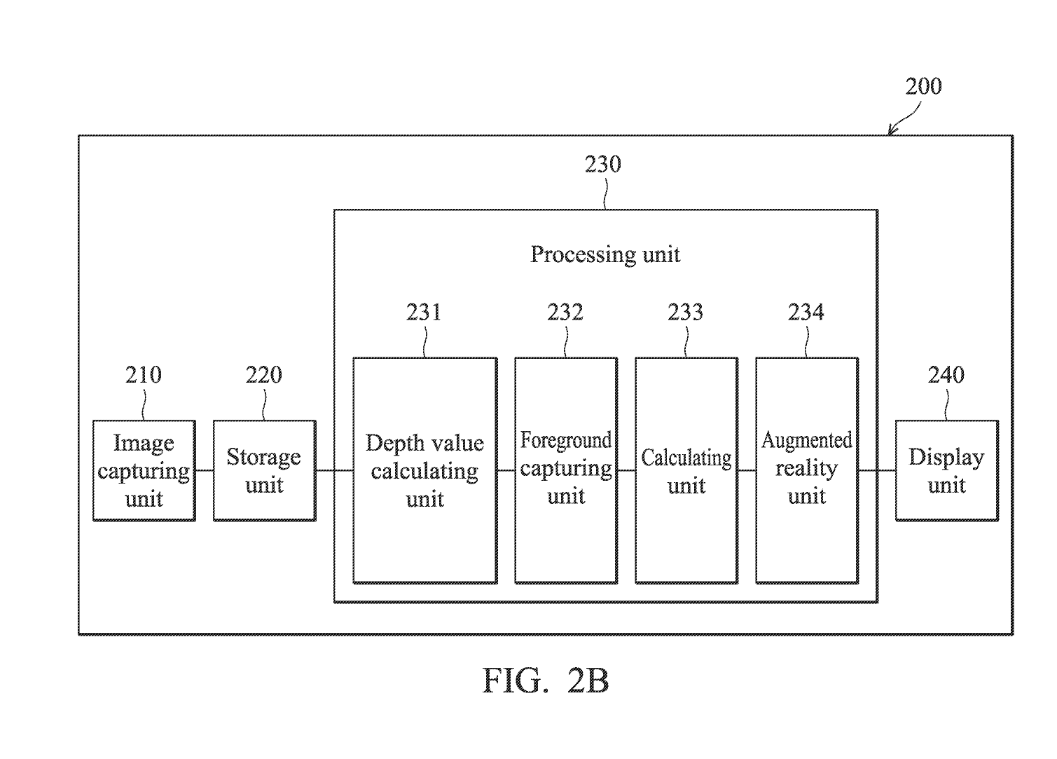

FIG. 2A is a block diagram of a system 200 used for generating an augmented reality according to a first embodiment of the present invention. The system 200 includes an image capturing unit 210, a storage unit 220 and a processing unit 230, wherein the processing unit 230 further includes a foreground capturing unit 232, a calculating unit 233 and an augmented reality unit 234.

The image capturing unit 210 is used to capture a 3D target image and a 3D environment image from a target and an environment respectively, wherein the 3D target image and the 3D environment image are the 3D images having depth values. The image capturing unit 210 may be a device or an apparatus which can capture 3D images, for example, a binocular camera/video camera having two lenses, a camera/video camera which can photograph two sequential photos, a laser stereo camera/video camera (a video device using laser to measure depth values), an infrared stereo camera/video camera (a video device using infrared rays to measure depth values), etc.

The storage unit 220 is coupled to the image capturing unit 210 and stores the 3D target images and the 3D environment images captured by the image capturing unit 210. The storage unit 220 may be a device or an apparatus which can store information, such as, but not limited to, a hard disk drive, memory, a Compact Disc (CD), a Digital Video Disk (DVD), etc.

The processing unit 230 is coupled to the storage unit 220 and includes the foreground capturing unit 232, the calculating unit 233 and the augmented reality unit 234. The foreground capturing unit 232 may capture a foreground image from the 3D target image. For example, the foreground capturing unit 232 separates the 3D target image into a plurality of object groups by using the image-clustering technique and displays the 3D target image to the user through an operation interface. Then, the user can select an object group as a foreground image from the plurality of object groups. For another example, the foreground capturing unit 232 may analyze and separate the 3D target image into a plurality of object groups according the depth value and the image-clustering technique. The object group with the lower depth value (that is, the object is close to the image capturing unit 210) is selected as a foreground image. Any known method for the image-clustering technique as mentioned above can be utilized, such as K-means, Fuzzy C-means, Hierarchical clustering, Mixture of Gaussians or other technologies. These technologies are not needed to be illustrated elaborately. According to a specified depth value, the calculating unit 233 estimates a display scale of the foreground image in a 3D image corresponding to the specified depth value. The specified depth value may be specified by a variety of methods. The methods will be presented in more detail in the following. The augmented reality unit 234 augments the foreground image in the 3D environment image according to the display scale estimated by the calculating unit 233, and then generates an augmented reality image.

Furthermore, the augmented reality unit 234 further includes an operation interface used to indicate the specified depth value in the 3D environment image. The operation interface may be integrated into the operation interface used to select objects. The operation interface and the operation interface used to select objects may also be the different operation interfaces independently.

In the first embodiment, the image capturing unit 210, the storage unit 220 and the processing unit 230 not only may be installed in an electronic device (for example, a computer, a notebook, a tablet PC, a mobile phone, etc.), but also may be installed in different electronic devices coupled to each other through the communication network, a serial interface (e.g., RS-232 and the like), or a bus.

FIG. 2B is a block diagram of a system 200 used for generating an augmented reality according to a second embodiment of the present invention. The system 200 includes an image capturing unit 210, a storage unit 220, a processing unit 230 and a display unit 240. The processing unit 230 further includes a foreground capturing unit 232, a calculating unit 233 and an augmented reality unit 234. The components having the same name as described in the first embodiment have the same function. The main difference between FIG. 2A and FIG. 2B is that the processing unit 230 further includes a depth value calculating unit 231 and the display unit 240. In the second embodiment, the image capturing unit 210 is a binocular camera having two lenses. The image capturing unit 210 may photograph a target and generate a left image and a right image corresponding to the target respectively. The image capturing unit 210 may also photograph an environment and generate a left image and a right image corresponding to the environment respectively. The left image and the right image corresponding to the target and the left image and the right image corresponding to the environment may also be stored in the storage unit 220. The depth value calculating unit 231 in the processing unit 230 calculates and generates a depth value of the 3D environment image according to the left image and the right image corresponding to the target. The details related to the 3D imaging technology of the binocular camera will be omitted since the 3D imaging technology of the binocular camera is known and belongs to prior art. The display unit 240 coupled to the processing unit 230 is configured to display the augmented reality image, wherein the display unit 240 may be a display, such as a cathode ray tube (CRT) display, a touch-sensitive display, a plasma display, a light emitting diode (LED) display, and so on.

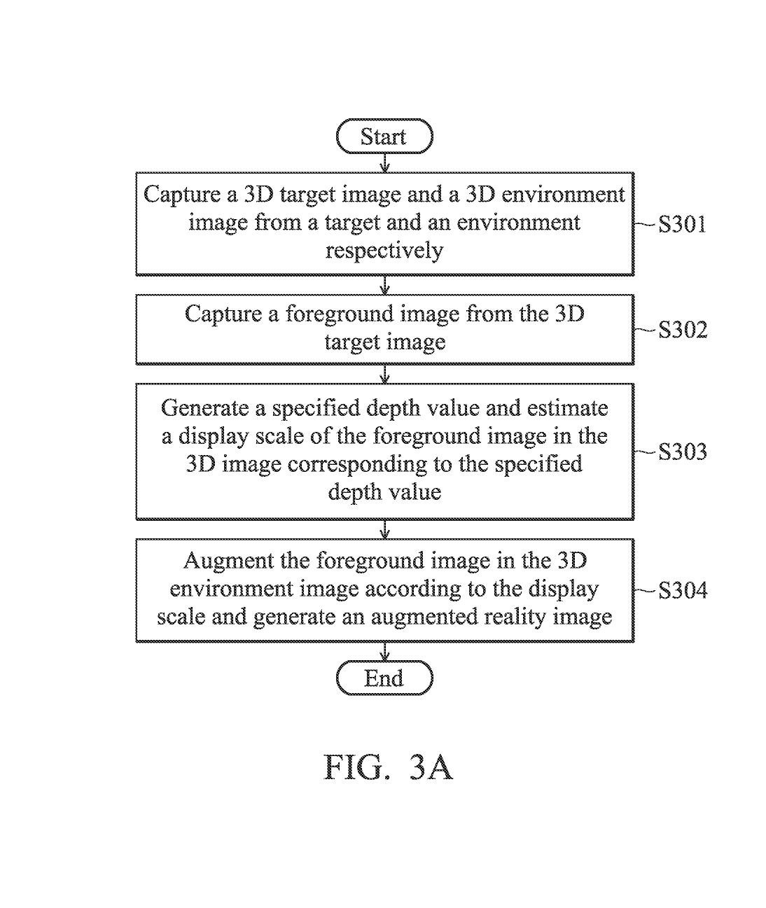

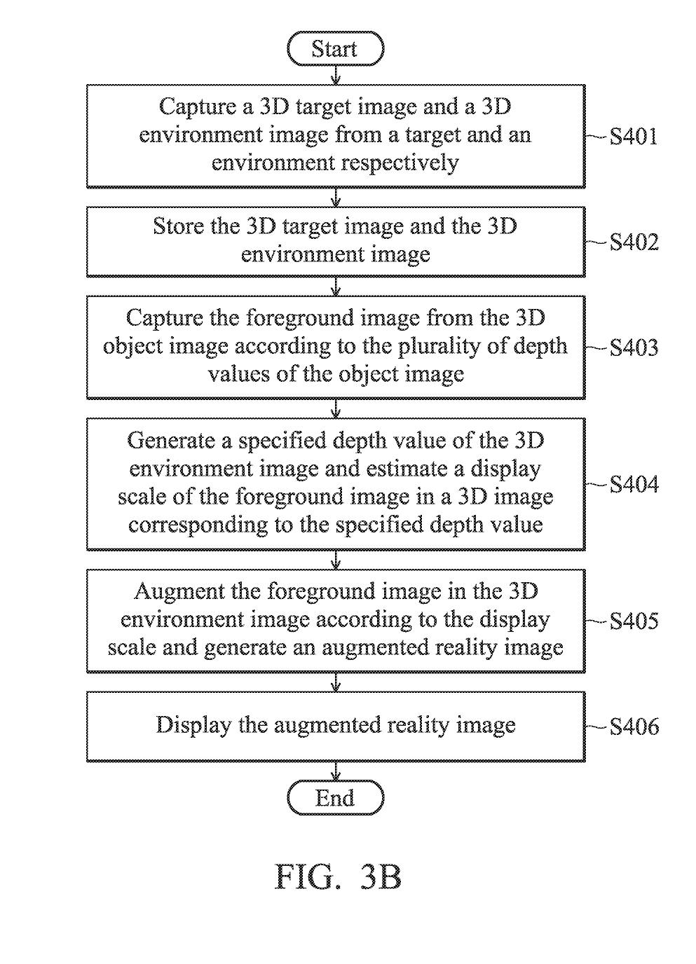

FIG. 3A is a flow diagram illustrating the augmented reality method used in the augmented reality system according to the first embodiment of the present invention with reference to FIG. 2A First, in step S301, the image capturing unit 210 captures a 3D target image and a 3D environment image from a target and an environment respectively, wherein the 3D target image and the 3D environment image are the 3D images having depth values. In step S302, the foreground capturing unit 232 captures a foreground image from the 3D target image. In step S303, the calculating unit 233 generates a specified depth value and estimates a display scale of the foreground image in the 3D image corresponding to the specified depth value. In step S304, the augmented reality unit 234 augments the foreground image in the 3D environment image according to the display scale estimated by the calculating unit 233, and then generates an augmented reality image. The details, as discussed previously, will be omitted.

FIG. 3B is a flow diagram illustrating the augmented reality method used in the augmented reality system according to the second embodiment of the present invention with reference to FIG. 2B. In step S401, the image capturing unit 210 captures a 3D target image and a 3D environment image from a target and an environment respectively. In step S402, after the image capturing unit 210 captures the 3D target image and the 3D environment image, the 3D target image and the 3D environment image are stored in the storage unit 220. It is noteworthy that the images captured by the image capturing unit 210 are 3D images and then the depth value calculating unit 231 does not need to calculate the depth value of the images. In another embodiment, the image capturing unit 210 is a binocular camera. The image capturing unit 210 photographs an object and generates a left image and a right image of the object. The depth value calculating unit 231 calculates the plurality of depth values of the object image according to the left image and the right image of the object. In step S403, the foreground capturing unit 232 captures the foreground image from the 3D object image according to the plurality of depth values of the object image. In step S404, the calculating unit 233 generates a specified depth value of the 3D environment image and estimates a display scale of the foreground image in a 3D image corresponding to the specified depth value. In step S405, the augmented reality unit 234 augments the foreground image in the 3D environment image, and then generates an augmented reality image. Finally, in step S406, the display unit 240 displays the augmented reality image.

In a third embodiment, the augmented reality system 200 may be applied to a mobile device which supports stereo vision. The user can use the mobile device to photograph the target image and the environment image, and then the target image is augmented in the environment image. The structure of the mobile device is almost the same as the structure of FIG. 2A. The mobile device includes an image capturing unit 210, a storage unit 220, a processing unit 230 and a display unit 240. The processing unit 230 further includes a foreground capturing unit 232, a calculating unit 233 and an augmented reality unit 234. In another embodiment, the mobile device further includes a communication unit (not shown in FIG. 2A) configured to connect to a remote service system for augmented reality. The calculating unit 233 is installed in the remote service system for augmented reality. In another embodiment, the mobile device further includes a sensor (not shown in FIG. 2A).

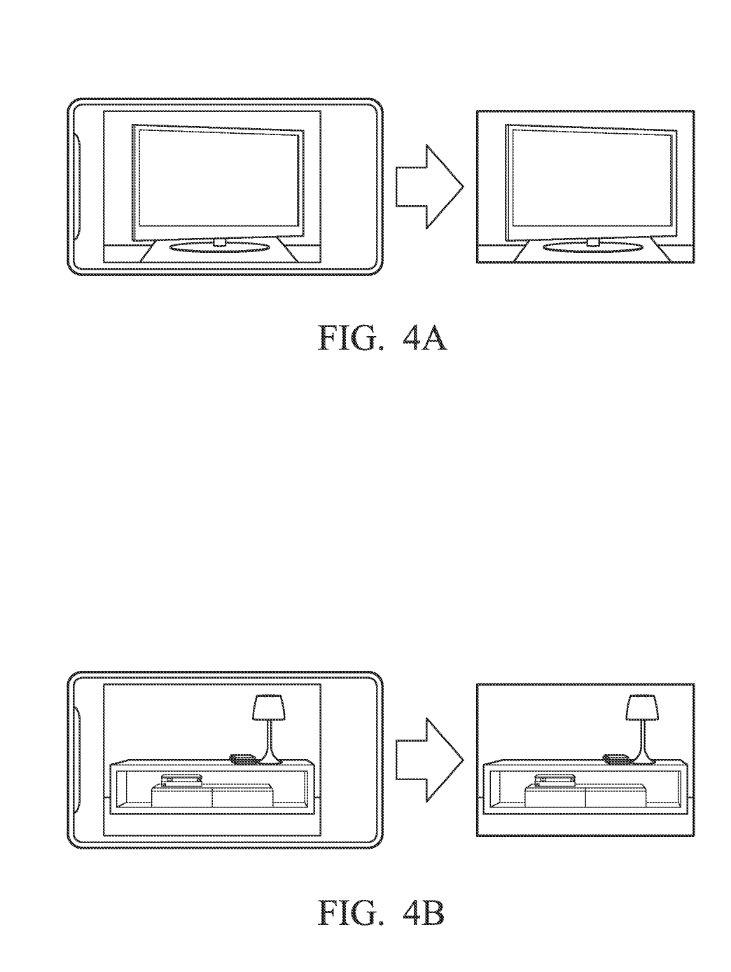

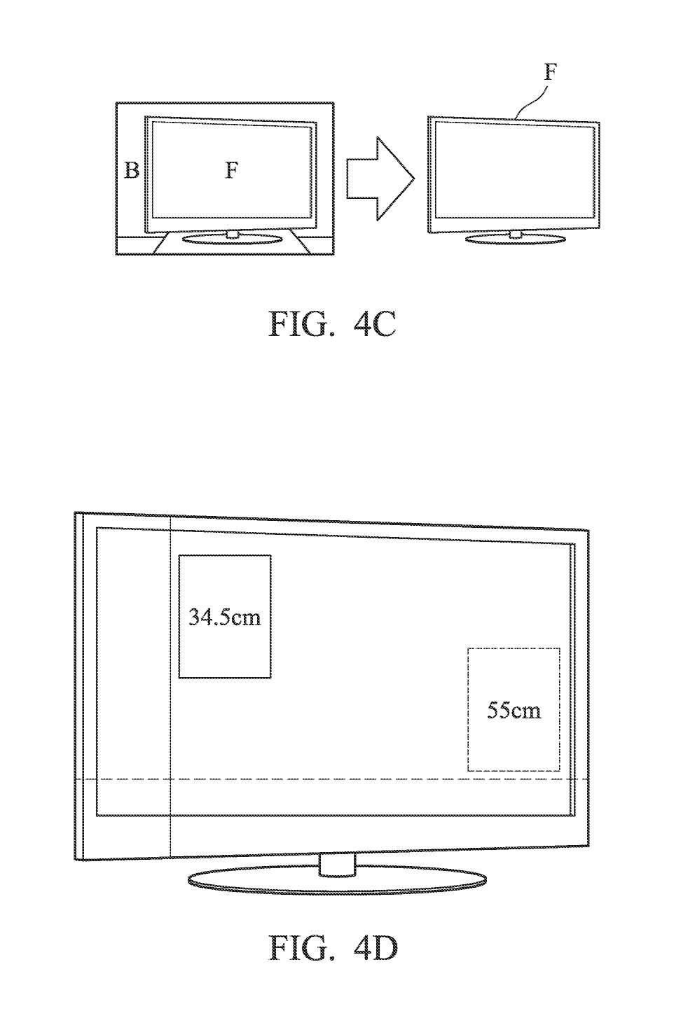

In this embodiment, a binocular video camera is used in the mobile device. The binocular video camera may be a camera which can simulate human binocular vision by using binocular lenses, and the camera may capture a 3D target image and an 3D environment image from a target and an environment, as shown in FIG. 4A and FIG. 4B. FIG. 4A is a schematic view illustrating the capturing of a 3D target image by an image capturing unit and FIG. 4B is a schematic view illustrating the capturing of a 3D environment image by an image capturing unit, wherein the 3D target image is an image having a depth value and the 3D environment image is an image having a depth value. The 3D images captured by the image capturing unit are stored in the storage unit 220.

In another embodiment, the image capturing unit 210 is a binocular camera. The image capturing unit 210 may capture a left image and a right image of an object, and the left image and the right image of the object are stored in the storage unit 220. The depth value calculating unit 231 calculates the plurality of depth values of the left image and the right image of the object respectively by using the dissimilarity analysis and the stereo vision analysis. The depth value calculating unit 231 may be installed in the processing unit of the mobile device, or may be installed in a remote service system for augmented reality. The mobile device transmits the left image and the right image of the object to the remote service system for augmented reality through a communication connection. After receiving the left image and the right image of the object, the remote service system for augmented reality calculates depth values of the object images and generates the 3D image. The 3D image is stored in the storage unit 220.

In the third embodiment, the foreground capturing unit 232 separates a foreground and a background according to the depth values of the 3D object image, as shown in FIG. 4C. FIG. 4C is a schematic view illustrating the capturing of a foreground image by an image capturing unit. In FIG. 4C, the region “F” is a foreground object that the depth is the shallowest, and the region “B” is a background environment that the depth is the deepest. The calculating unit 233 generates a specified depth value, and estimates the display scales of the foreground image based on a variety of depth values.

The calculating unit 233 in each embodiment of the present invention can further provide a reference scale to estimate the display scale of the foreground object. The reference scale can be a conversion table calculated by the capturing unit 233 according to the image (the 3D target image and the 3D environment image) captured by the image capturing unit 210. The actual scale and the display scale of the object image corresponding to the plurality of depth values may be calculated according to the conversion table. The calculating unit 233 calculates the actual scale of the foreground object according to the depth value, the display scale and the reference scale of the foreground image in the 3D object image, and then estimates the display scale of the foreground object according to the actual scale, the reference scale and the specified depth value of the foreground image. Furthermore, the calculating unit 233 may display the actual scale data of the foreground image. As shown in FIG. 4D, the height of the foreground image indicated by the solid line is 34.5 centimeters (cm), and the width of the foreground image indicated by the dashed line is 55 centimeters (cm).

The augmented reality unit 234 in each embodiment of the present invention may further include an operation interface configured to indicate the specified depth value in the 3D environment image. Then, the augmented reality unit 234 augments the foreground image in the specified depth value of the 3D environment image and generates the augmented reality image.

The operation interface may be classified into several different types. The different embodiments will be presented to illustrate the different operation interfaces in the following invention.

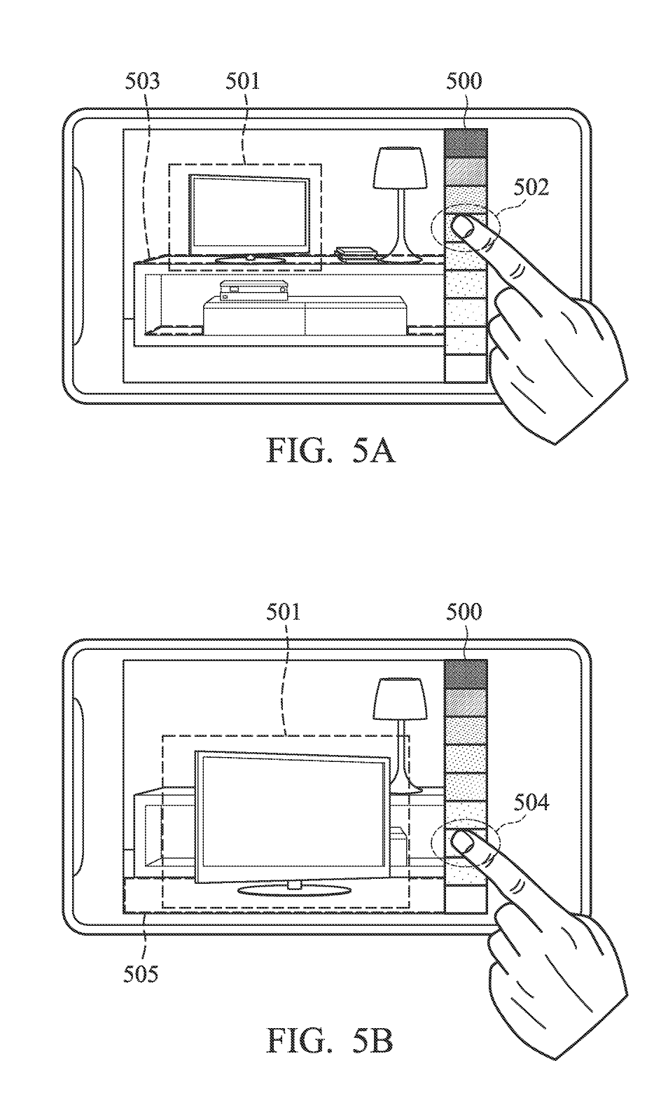

FIGS. 5A-5B are schematic views illustrating the operation interface according to an embodiment of the present invention. As shown in FIG. 5A-5B, the user selects a depth value as a specified depth value in the 3D environment image through a control bar 500. In FIG. 5A-5B, the user can select different depth values through the control bar 500. The foreground image is scaled to the correct scale automatically in the depth, and the region corresponding to the depth is shown on the display immediately. For example, in FIG. 5A, the user selects a depth value 502 in the control bar 500, and then the region 503 indicated by the dashed line corresponding to the depth value 502 is shown on the display. In FIG. 5B, the user selects another depth value 504 in the control bar 500, and then the another region 505 indicated by the dashed line corresponding to the depth value 504 is shown on the display. Finally, the user moves the foreground image to the region corresponding to the depth value the user wants.

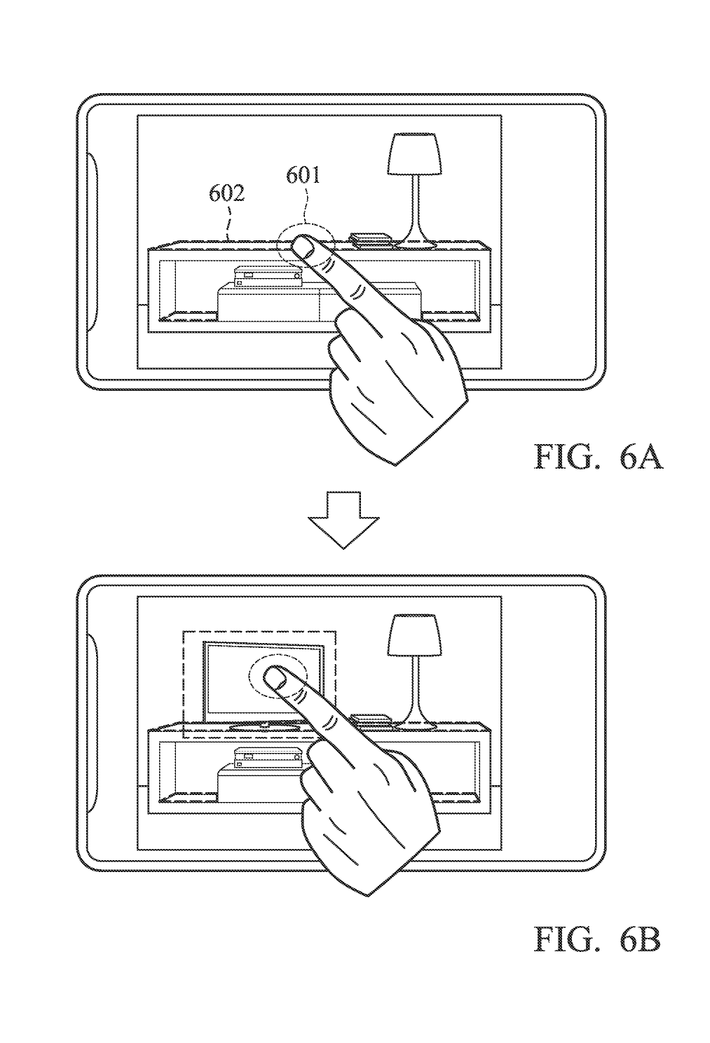

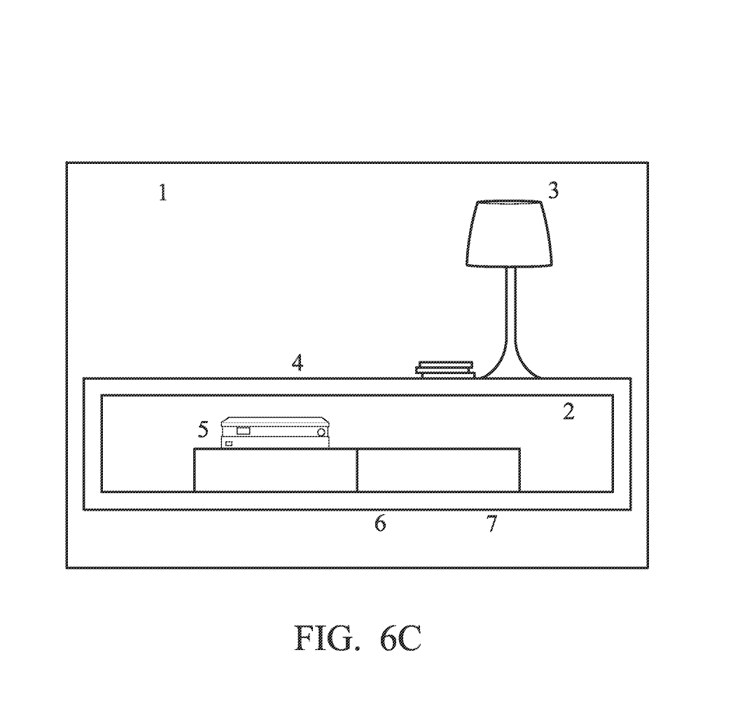

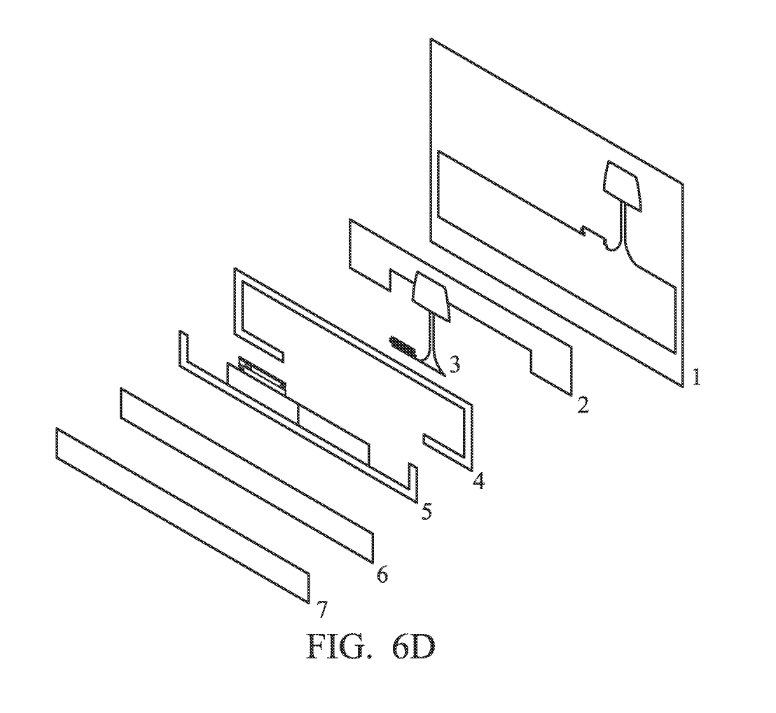

FIGS. 6A-6B are schematic views illustrating the operation interface according to an embodiment of the present invention. As shown in FIG. 6A, after selecting the foreground image, the user selects an region as a specified region among a plurality of regions of the 3D environment image, wherein the 3D environment image is divided into the plurality of regions. The user can select a specified region 601 that the user wants to place the foreground image. The region (the region 602 indicated by the dashed line) which the depth value is the same as the specified region 601 is shown on the display. In FIG. 6B, the foreground image is scaled to the correct scale corresponding to the depth value automatically, and then the user moves the foreground image to a position in the specified region 601. FIGS. 6C-6D are schematic views illustrating the sequence of the depth value of the operation interface according to an embodiment of the present invention. As shown in FIGS. 6C-6D, there is an ordered sequence among the plurality of regions of the 3D environment image. The ordered sequence of the depth value from deep to shallow may be divided into 7 regions (the parameters 1-7). The augmented reality system 200 may detect a signal the user inputs through the sensor. After the augmented reality system receives the signal, the operation interface of the augmented reality system 200 selects the specified region from the plurality of regions of the 3D environment image according to the ordered sequence of the depth value.

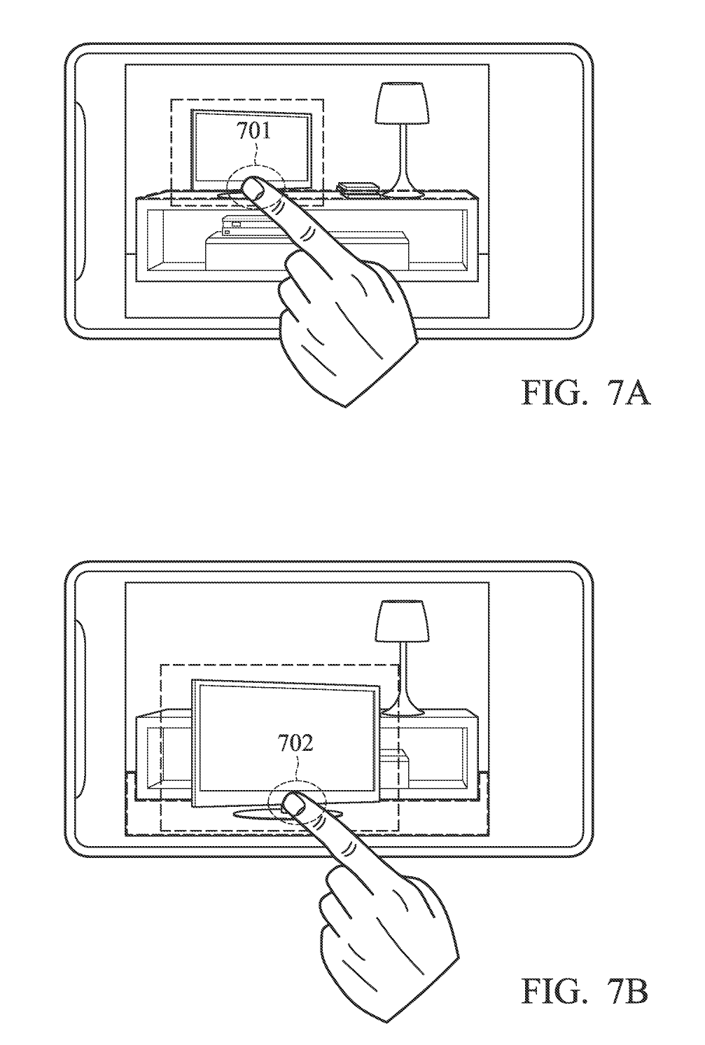

FIGS. 7A-7B are schematic views illustrating the operation interface according to an embodiment of the present invention. The 3D environment image includes a plurality of environment objects. After selecting the foreground image, the user moves the foreground image to a position of an environment object among the plurality of environment objects of the 3D environment image. As shown in FIGS. 7A-7B, according to the positions 701 and 702 the user touches, the regions which the foreground image is placed in are shown immediately. The scales of the foreground image is scaled and shown automatically according to the correct scales corresponding to the positions which the foreground image is placed in.

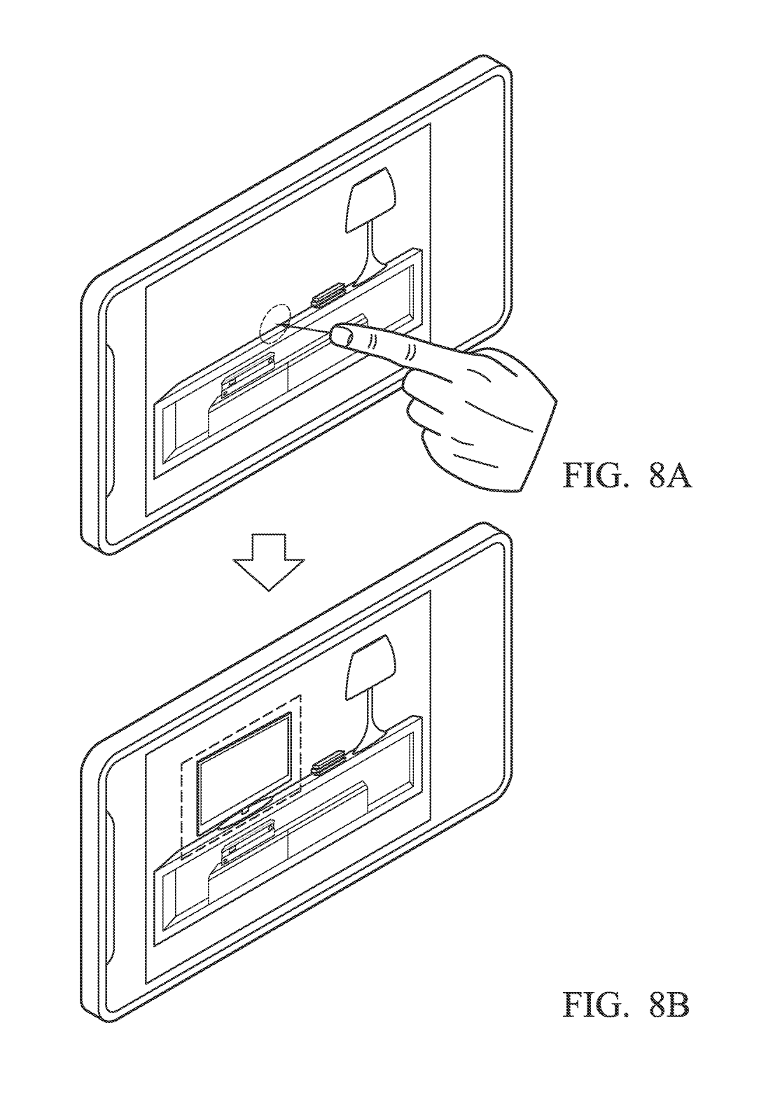

FIGS. 8A-8B are schematic views illustrating the operation interface according to an embodiment of the present invention. The operation interface is a 3D operation interface. As shown in FIGS. 8A-8B, the user can change the display mode of the 3D target image and the 3D environment image by using the 3D operation interface. Then, the user can select the specified depth value by using a touch control device or an operating device. In an embodiment, the touch control device may change the stereoscopic variation of displaying the 3D target image and the 3D environment image by detecting the strength of the force the user imparts, the duration time of the user touching the touch control device or the operating device, and so on. In another embodiment, the operating device is an external rocker and the like.

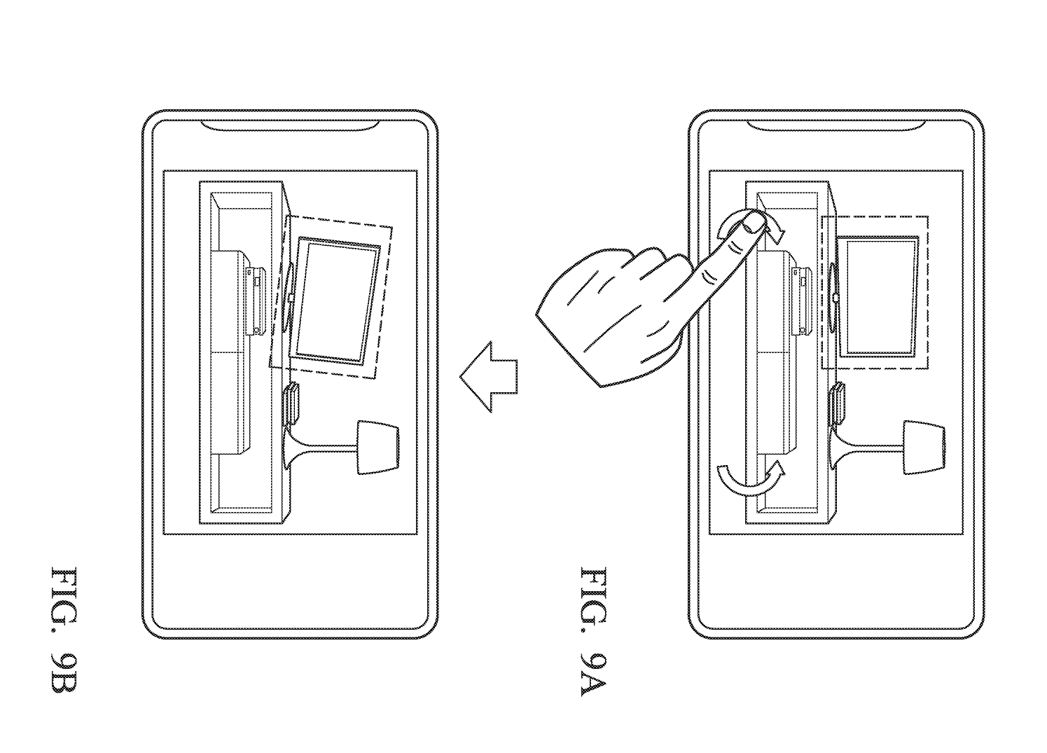

FIGS. 9A-9B are schematic views illustrating the operation interface according to an embodiment of the present invention. As shown in FIGS. 9A-9B, the user can use a keyboard, a virtual keyboard, drag, a sensor (e.g. a gyroscope) or a 3D control device and so on to control the rotating angle of the foreground object.

Therefore, there is no need for the user to use a specific pattern and a specific scale. The actual scale of the image may be estimated and shown on the display through the augmented reality methods and systems to achieve the result of generating the augmented reality.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for augmented reality, comprising:
capturing a 3D target image and a 3D environment image from a target and an environment respectively, wherein the 3D target image and the 3D environment image are the 3D images with the depth values;
capturing a foreground image from the 3D target image;
estimating a display scale of the foreground image in a 3D environment image corresponding to a specified depth value according to the specified depth value in the 3D environment image; and
augmenting the foreground image in the 3D environment image according to the display scale and generating an augmented reality image.

2. The method for augmented reality as claimed in claim 1, wherein the step of estimating the display scale of the foreground image in the 3D environment image corresponding to a specified depth value comprises providing a reference scale to estimate the display scale of the foreground object, wherein the reference scale comprises an actual scale and the display scale corresponding to a plurality of depth values of the images captured by a image capturing unit respectively, and the 3D target image and the 3D environment image are captured by the image capturing unit.

3. The method for augmented reality as claimed in claim 2, wherein the step of estimating the display scale of the foreground image according to the reference scale comprises calculating the actual scale of the foreground image according to the depth value, the display scale and the reference scale of the foreground image and estimating the display scale of the foreground image according to the actual scale, the reference scale and the specified depth value of the foreground image.

4. The method for augmented reality as claimed in claim 1, further comprising providing an operation interface configured to indicate the specified depth value in the 3D environment image.

5. The method for augmented reality as claimed in claim 4, further comprising:
capturing, by the operation interface, the foreground image from the 3D target image; and
placing, by the operation interface, the foreground image in the 3D environment image corresponding to the specified depth value.

6. The augmented reality method as claimed in claim 4, wherein the operation interface is a control bar configured to indicate the specified depth value in the 3D environment image.

7. The method for augmented reality as claimed in claim 4, wherein the 3D environment image is divided into a plurality of regions, and the method further comprises:
selecting, by the operation interface, the foreground image;
selecting, by the operation interface, a specified region among the plurality of regions of the 3D environment image; and
placing, by the operation interface, the foreground image in a position in the specified region.

8. The method for augmented reality as claimed in claim 7, wherein the 3D environment image comprises a plurality of environment objects, and the method further comprises:
selecting, by the operation interface, the foreground image; and
dragging, by the operation interface, the foreground image in a position of an environment object among the plurality of environment objects in the 3D environment image.

9. The method for augmented reality as claimed in claim 1, wherein the 3D environment image is divided into a plurality of regions and there is an ordered sequence among the plurality of regions, the method further comprises detecting a signal through a sensor, selecting a specified region among the plurality of regions in the 3D environment image according to the ordered sequence when receiving the signal, and placing the foreground image in a position in the specified region.

10. A system for augmented reality, comprising
an image capturing unit, configured to capture a 3D target image and a 3D environment image from a target and an environment respectively, wherein the 3D target image and the 3D environment image are the 3D images with the depth values;
a storage unit, coupled to the image capturing unit and configured to store the 3D target image and the 3D environment image;
a processing unit, coupled to the storage unit, comprising:
a foreground capturing unit, configured to capture a foreground image from the 3D target image;
a calculating unit, configured to estimate a display scale of the foreground image in a 3D environment image corresponding to a specified depth value according to the specified depth value in the 3D environment image; and
an augmented reality unit, configured to augment the foreground image in the 3D environment image according to the display scale and generate an augmented reality image.

11. The system for augmented reality as claimed in claim 10, wherein the calculating unit further provides a reference scale to estimate the display scale of the foreground object, and the reference scale comprises an actual scale and the display scale corresponding to a plurality of depth values of the images captured by the image capturing unit respectively, wherein the 3D target image and the 3D environment image are captured by the image capturing unit.

12. The system for augmented reality as claimed in claim 11, wherein the calculating unit further calculates the actual scale of the foreground image according to the depth value, the display scale and the reference scale of the foreground image, and estimates the display scale of the foreground image according to the actual scale, the reference scale and the specified depth value of the foreground image.

13. The system for augmented reality as claimed in claim 10, wherein the augmented reality unit further comprises an operation interface configured to indicate the specified depth value in the 3D environment image.

14. The system for augmented reality as claimed in claim 13, wherein the operation interface is further configured to capture the foreground image from the 3D target image, and place the foreground image in the 3D environment image corresponding to the specified depth value.

15. The system for augmented reality as claimed in claim 13, wherein the operation interface is a control bar configured to indicate the specified depth value in the 3D environment image.

16. The system for augmented reality as claimed in claim 13, wherein the 3D environment image is divided into the plurality of regions, and the operation interface selects a specified region among the plurality of regions of the 3D environment image after selecting the foreground image, and the operation interface places the foreground image in a position in the specified region.

17. The system for augmented reality as claimed in claim 13, wherein the 3D environment image comprises a plurality of environment objects, and the operation interface selects the foreground image and drags the foreground image in a position of an environment object among the plurality of environment objects in the 3D environment image.

18. The system for augmented reality as claimed in claim 10, wherein the image capturing unit is a binocular camera configured to photograph a target and generate a left image and a right image corresponding to the target, and photograph an environment and generate a left image and a right image corresponding to the environment, and the processing unit further comprises:
a depth value calculating unit, configured to calculate and generate the depth value of the 3D target image according to the left image and the right image of the target, and calculate and generate the depth value of the 3D environment image according to the left image and the right image of the environment.

19. A mobile device for augmented reality, comprising
an image capturing unit, configured to capture a 3D target image and a 3D environment image from a target and an environment respectively, wherein the 3D target image and the 3D environment image are the 3D images with the depth values;
a storage unit, coupled to the image capturing unit and configured to store the 3D target image and the 3D environment image;
a processing unit, coupled to the storage unit, comprising:
a foreground capturing unit, configured to capture a foreground image from the 3D target image;
a calculating unit, configured to estimate a display scale of the foreground image in a 3D environment image corresponding to a specified depth value according to the specified depth value in the 3D environment image; and
an augmented reality unit, configured to augment the foreground image in the 3D environment image according to the display scale and generate an augmented reality image; and
a display unit, coupled to the processing unit and configured to display the augmented reality image.

20. The mobile device for augmented reality as claimed in claim 19, wherein the 3D environment image is divided into the plurality of regions and there is an ordered sequence among the plurality of regions, the mobile device further comprises:
a sensor, coupled to the processing unit and configured to detect a signal and transmit the signal to the processing unit,
wherein when the processing unit receives the signal, the operation interface selects a specified region among the plurality of regions in the 3D environment image according to the ordered sequence and places the foreground image in a position in the specified region.
